(19) United States
(12) Patent Application Publication
(10) Pub. No.: US 2025/0377961 A1
(43) Pub. Date: Dec. 11, 2025

(54) Computer System and Method for Detecting a Failure of a Power Supply Voltage in the Computer System

(71) Applicant: Siemens Aktiengesellschaft, Muenchen (DE)

(72) Inventors: Sergej KANDLIN, Karlsruhe (DE); Thomas SCHARDEIN, Kleinfischlingen (DE); Timo ANDLAUER, Jockgrim (DE); Andreas HUBER, Sinzheim (DE)

(21) Appl. No.: 19/231,972

(22) Filed: Jun. 9, 2025

(30) Foreign Application Priority Data
Jun. 11, 2024 (EP) 24181399

(51) Int. Cl. G06F 11/07; G06F 1/30

(52) U.S. Cl. CPC G06F 11/0757; G06F 1/30; G06F 2211/1097

(57) ABSTRACT

Computer system and method for detecting failure of a mains supply voltage in the system, wherein a first control unit monitors the mains supply voltage, a second control unit monitors whether a system voltage fails, a start-up delay circuit is operated for renewed boot-up of the system after failure of the mains supply voltage to generate an enable signal for boot-up of the system, where the enable signal is set to a low level when the mains voltage signal has the low level, if the mains voltage signal has the high level again, and a delay timer is started with a delay time, and if the delay time has elapsed, then the enable signal for the boot-up is set again to the high level in order to detect whether a computer system has been shut down regularly and/or intentionally, or has crashed on account of an unexpected mains failure.

### BACKGROUND OF THE INVENTION

### 1. Field of the Invention

The invention relates to a method for detecting a failure of a power supply voltage in a computer system, which is operated by way of the power supply voltage via a system voltage, wherein a first control unit monitors the power supply voltage and in the presence of a supply voltage keeps a mains voltage signal at a high level and, in instances in which the power supply voltage fails, sets the mains voltage signal to a low level.

### 2. Description of the Related Art

Particularly after a mains failure, a restart may be unsuccessful in the case of computer systems or PCs. In practice, the computer system may not restart sporadically following an unexpected power failure.

### SUMMARY OF THE INVENTION

It is an object of the present invention to provide and system and method for avoiding a sporadic failure to restart a PC following unexpected power failures.

This and other objects and advantages are achieved in accordance with the invention by a method in which a second control unit is operated so as to monitor a system voltage and, in the presence of the system voltage, keeps a board voltage signal at a high level and, in instances in which the system voltage fails, sets the board voltage signal to a low level.

In addition, a detection circuit is operated to evaluate a mains voltage signal and the board voltage signal and, in the instance that the mains voltage signal has a low level and the board voltage signal has a high level, failure of the mains supply voltage is detected. For a renewed boot-up of the computer system after failure of the mains supply voltage, a start-up delay circuit is operated to generate an enable signal for the boot-up of the computer system, where the enable signal is set to a low level when the mains voltage signal has the low level, if the mains voltage signal again has the high level, then a delay timer with a delay time is started, and if the delay time elapses, then the enable signal for the boot-up is again set to the high level.

The method or a corresponding circuit for an automatic start-up delay can be integrated in a boot-up sequence circuit of the PC. It detects whether the PC has shut down regularly and/or intentionally or has crashed on account of an unexpected power failure. With a restart following a power failure, the circuit or the method triggers a 4 second delay, for instance, in order to discharge all residual voltages on the motherboard and then to boot up from OV. With an initial activation or after a regular shutdown, there is no 4 second delay and the PC starts immediately.

The objects and advantages are similarly achieved in accordance with the invention by a computer system that comprises a power supply unit configured to provide a system voltage from a power supply voltage, a first control unit configured to monitor the power supply voltage and, in the presence of a supply voltage, to output a mains voltage signal as a high level and in instances in which the mains supply voltage fails, to set the mains voltage signal to a low level. The system also comprises a second control unit configured to monitor the system voltage, and in the presence of a system voltage, to output a board voltage signal at a high level, and in instances in which the system voltage fails, to set the board voltage signal to a low level.

Additionally included in the system is a detection circuit configured to evaluate the mains voltage signal and the board voltage signal and, in instances in which the mains voltage signal has a low level and the board voltage signal a high level, failure of the mains supply voltage is detected and a failure marker is set. The further includes a start-up delay circuit that is configured to generate an enable signal for the boot-up of the computer system for a renewed boot-up of the computer system after failure of the mains supply voltage, configured to set the enable signal to a low level when the mains voltage signal has the low level and when the mains voltage signal again has the high level, to start a delay timer with a delay time, and further configured to set the enable signal for the boot-up again to the high level after the delay time has elapsed.

The circuit for an automatic start-up delay can be integrated in a boot-up sequence circuit of the PC. It identifies whether the PC has been regularly/intentionally shut down or has crashed on account of an unexpected mains failure. With a restart after a mains failure, the circuit triggers a delay to discharge all residual voltages on the motherboard and to boot up from OV. With an initial activation or after a regular shutdown, there is no 4 second delay and the PC starts immediately.

In the case of a mains failure, the mains voltage signal from the power supply immediately goes to the low level before the board voltages leave the tolerance range. That is, the condition of the mains voltage signal equating to “low” and board voltage signal grade still being “high” is the criterion for the detection of the unexpected power failure.

The enable signal for a renewed boot-up of the start-up delay circuit PM_P3V3D_PCH_EN goes to “low” in synchrony with the mains voltage signal from the first control unit and is kept at a “low” level by the start-up delay circuit until
1) the power supply unit is started up again and the mains voltage signal delivers “high” and
2) until the delay time for the discharge of the board voltage has elapsed. The circuit subsequently outputs the enable signal “high” and the boot-up of the computer system or the PC can be continued.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Using the drawings, in which an exemplary embodiment of the inventions are illustrated, the invention and its embodiments are explained below, in which:

FIG. 1 shows a schematic block diagram of a computer system in accordance with the invention;

FIG. 2 shows a graphical plot of a time diagram with an unexpected power failure;

FIG. 3 shows a graphical plot of a time diagram with a regular boot-up; and

FIG. 4 is a flowchart of the method in accordance with the invention.

### DETAILED DESCRIPTION OF THE EXEMPLARY EMBODIMENTS

The proposed invention addresses the problem of the sporadic failure of computer systems or PCs to start after unexpected mains failures, as a result of an integration of a start-up delay circuit in a boot-up sequence, which ensures that residual voltages on the motherboard are discharged before a restart. The solution is better than using load resistors because they are only active when required and thus improves the efficiency and costs of the devices.

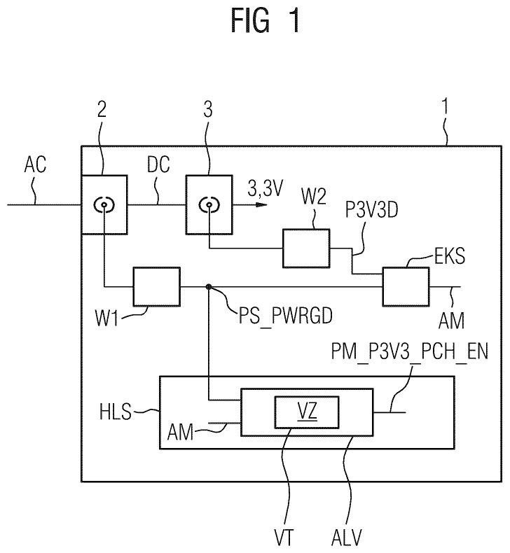

With reference to FIG. 1, a computer system 1 similar to an industrial PC is shown. The computer system 1 has a power supply unit 2, which is configured to provide a system voltage DC from a mains supply voltage AC. In order to realize detection of a failure of the mains supply voltage AC in the computer system 1, a first control unit W1 is available that is configured to monitor the mains supply voltage AC and in the presence of a mains supply voltage AC keeps a mains voltage signal PS_PWRGD at a high level. In the event that the mains supply voltage AC fails, the mains voltage signal PS_PWRGD is set to a low level.

A second control unit W2 is operated such that the system voltage DC is monitored, and in the presence of a system voltage DC a board voltage signal P3V3D is kept at a high level. In the instance that the system voltage DC fails, the board voltage signal P3V3D is set to a low level.

In order now to detect that an unexpected mains interruption exists or existed, a detection circuit EKS is operated such that the mains voltage signal PS_PWRGD and the board voltage signal P3V3D is evaluated. In the event that the mains voltage signal PS_PWRGD has a low level and the board voltage signal P3V3D a high level, failure of the mains supply voltage AC is detected.

In order now to avoid a sporadic non-restart on account of residual voltages still present on the motherboard, a start-up delay circuit ALV is operated within a boot-up circuit HLS. In the start-up delay circuit ALV, an enable signal PM_P3V3D_PCH_EN is generated for the boot-up of the computer system 1. To this end, the failure marker AM of the detection circuit EKS is used inter alia. The enable signal PM_P3V3D_PCH_EN is kept at a low level until the mains voltage signal PS_PWRGD again has a high level and a delay timer VT with a delay time VZ, preferably four seconds, has elapsed. The start-up delay circuit ALV accordingly has the delay timer VT with a delay time VZ.

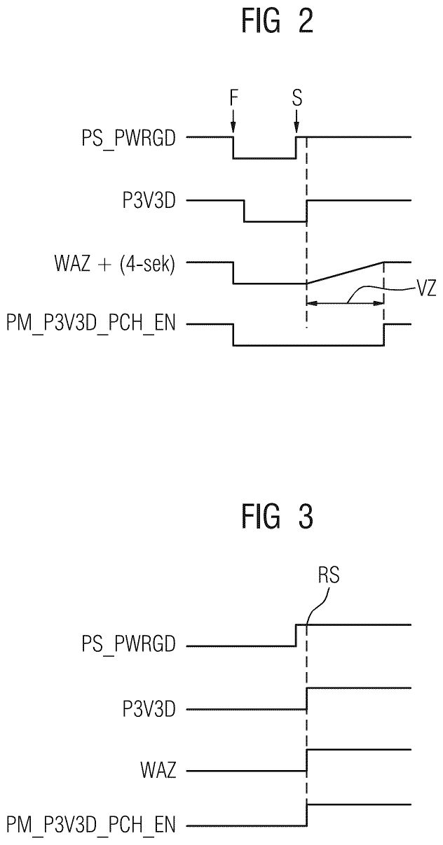

With reference to FIG. 2, a graphical plot of time diagram with an unexpected mains voltage failure is shown. The individual signals are shown in their temporal course. From the time instant of a failure F of the mains supply voltage AC, the mains voltage signal PS_PWRGD goes from a high level to a low level. At this time instant, the board voltage signal P3V3D is still at a high level, where the start-up delay circuit ALV nevertheless already revokes the enable signal PM_P3V3D_PCH_EN. At a time instant S, at which the computer system 1 is to boot up again, as visible in the restart time WAZ, the delay time VZ is awaited and the enable signal PM_P3V3D_PCH_EN is set again to high level only after the delay timer VT with the delay time VZ has expired.

FIG. 3 shows a graphical plot of a time diagram for a regular boot-up. A delay time VZ need not be adhered to here. The mains voltage signal PS_PWRGD already has a high level and therefore shows that the mains supply voltage AC and accordingly the system voltage DC is ready. Since the motherboard now has to be precharged for a brief time instant, the board voltage signal P3V3D is set to a high level with a slight time delay.

The restart time WAZ is now significantly shorter, since the enable signal PM_P3V3D_PCH_EN is immediately set to high level at the as yet unstarted delay time VZ.

In an industrial environment, both an AC mains voltage and also a DC mains voltage is possible, the reference characters are only selected by way of example and have no restrictive significance with respect to the type of voltage.

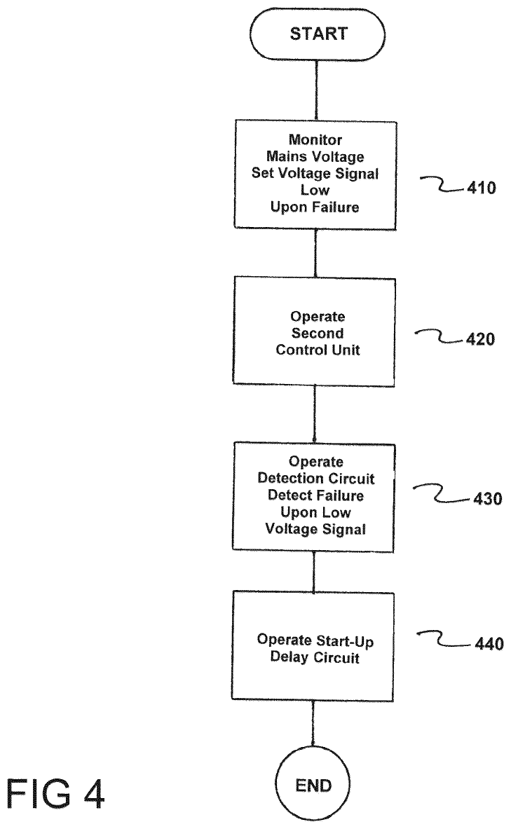

FIG. 4 is a flowchart of the method for detecting a failure of a mains power supply voltage in a computer system 1, which is operated by way of the power supply voltage AC via a system voltage DC. The method comprises monitoring, by a first control unit W1, the mains power supply voltage AC and, when the mains power supply voltage AC is present, keeping the mains voltage signal PS_PWRGD at a high level and, in cases in which the mains supply voltage AC fails, setting the mains voltage signal PS_PWRGD to a low level, as indicated in step 410.

Next, a second control unit W2 is operated to monitor a system voltage DC and, when a system voltage DC is present, a board voltage signal P3V3D is kept at the high level and, in cases in which the system voltage DC fails, the board voltage signal P3V3D is set to a low level, as indicated in step 420.

Next, a detection circuit EKS is operated to evaluate the mains voltage signal PS_PWRGD and the board voltage signal P3V3D and, in instances in which the mains voltage signal PS_PWRGD has a low level and the board voltage signal P3V3D has a high level, a failure of the mains power supply voltage AC is detected, as indicated in step 430.

Next, a start-up delay circuit ALV is operated to generate an enable signal PM_P3V3D_PCH_EN for a boot-up of the computer system 1 for a renewed boot-up of the computer system (1) after failure of the mains power supply voltage (AC), as indicated in step 440.

In accordance with the inventive method, the enable signal PM_P3V3D_PCH_EN is set to a low level when the mains power voltage signal PS_PWRGD has the low level, if the mains voltage signal PS_PWRGD has the high level again, where a delay timer VT is started with a delay time VZ. In addition, if the delay time VZ has elapsed, then the enable signal PM_P3V3D_PCH_EN for the boot-up is reset to the high level.

The mains voltage signal PS_PWRGD is not expediently a monitoring signal from an output of a system power supply unit or power suppl. A mains monitoring can additionally be implemented within the system power supply unit. It is also not possible, however, that the power supply does not start up at the correct mains input. In the instance, PS_PWRGD=low remains. PS_PWRGD=high has the meaning that mains (DC-direct current or AC-alternating current) is OK and the system power supply unit runs correctly and the output voltage is in the tolerance.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for detecting a failure of a mains power supply voltage in a computer system, which is operated by way of the power supply voltage via a system voltage, the method comprising:
monitoring, by a first control unit, the mains power supply voltage and, when the mains power supply voltage is present, keeping the mains voltage signal at a high level and, in cases in which the mains supply voltage fails, setting the mains voltage signal to a low level;
operating a second control unit to monitor a system voltage and, when a system voltage is present, keeping a board voltage signal at the high level and, in cases in which the system voltage fails, setting the board voltage signal to a low level;
operating a detection circuit to evaluate the mains voltage signal and the board voltage signal and, in instances in which the mains voltage signal has a low level and the board voltage signal has a high level, detecting a failure of the mains power supply voltage; and
operating a start-up delay circuit to generate an enable signal for a boot-up of the computer system for a renewed boot-up of the computer system after failure of the mains power supply voltage;
wherein the enable signal is set to a low level when the mains power voltage signal has the low level, if the mains voltage signal has the high level again, a delay timer being started with a delay time; and
wherein if the delay time has elapsed, the enable signal for the boot-up is reset to the high level.

2. The method as claimed in claim 1, wherein the operation of the start-up delay circuit is executed within a boot-up sequence of the computer system.

3. A computer system comprising:
a power supply unit configured to provide a system voltage from a mains power supply voltage;
a first control unit configured to monitor the mains power supply voltage and, when the mains power supply voltage is present, to output a mains voltage signal as a high level and, in an event in which the mains power supply voltage fails, to set the mains voltage signal to a low level;
a second control unit configured to monitor the system voltage and, when the system voltage is present, to output a board voltage signal to a high level and, in instances in which the system voltage fails, to set the board voltage signal to a low level;
a detection circuit configured to evaluate the mains voltage signal and the board voltage signal and, in instances in which the mains power voltage signal has a low level and the board voltage signal has a high level, detect failure of the mains supply voltage and set a failure marker; and
a start-up delay circuit configured to initiate a renewed boot-up of the computer system after failure of the mains powers supply voltage to generate an enable signal for the boot-up of the computer system, configured to set the enable signal to a low level when the mains voltage signal has the low level and, when the mains voltage signal has the high level again, to start a delay timer with a delay time, and configured to, after the delay time has elapsed, set the enable signal for the boot-up back to the high level.
